(19) United States
(12) Patent Application Publication
(10) Pub. No.: US 2026/0296523 A1
(43) Pub. Date: Oct. 1, 2026

(54) Device for Limiting Rotation of a Vehicle Steering Shaft

(71) Applicant: Willi Elbe Gelenkwellen GmbH & Co. KG, Tamm (DE)

(72) Inventors: Jörg HAUHOFF, Altdorf (DE); Thomas HERRLICH, Putzbrunn (DE); Ralf SEDLMEIER, Pleidelsheim (DE); Aleksandar ANTONOV, Izbeglii (BG)

(73) Assignee: Willi Elbe Gelenkwellen GmbH & Co. KG, Tamm (DE)

(21) Appl. No.: 19/632,031

(22) Filed: Mar. 27, 2026

(30) Foreign Application Priority Data
Mar. 31, 2025 (DE) 10 2025 001 149.0

(51) Int. Cl. B62D 3/02

(52) U.S. Cl. CPC B62D 3/02

(57) ABSTRACT

A device serves to limit rotation of a steering shaft (3) of a vehicle. The steering shaft (3) is surrounded by an outer tube (2). Counter-stops (20, 21) associated with the steering shaft (3) come into contact with stops (27, 28) when the steering shaft (3) has reached its rotational end position. The stops (27, 28) are fixed in the outer tube (2) and are penetrated by the steering shaft (3). The counter-stops (20, 21) are part of a grooved sleeve (5), which is rotationally fixed but axially displaceable connected to the steering shaft (3). The grooved sleeve (5) has a helical groove (12), into which at least one engagement element (15) fixed to the outer tube (2) engages.

### CROSS-REFERENCE TO RELATED APPLICATION

This application claims the benefit of German Patent Application DE 10 2025 001 149.0, filed on Mar. 31, 2025, the content of which is incorporated in its entirety.

### TECHNICAL FIELD

The disclosure relates to a device for limiting rotation of a steering shaft of a vehicle, that is, for limiting a maximum angle through which the steering shaft can be rotated.

### BACKGROUND

Generally, devices for limiting the rotation of a steering shaft require a relatively large installation space and are expensive to procure.

The disclosure is based on the object of configuring the generic device in such a way that, without impairment of its function, it requires only little installation space and can be manufactured cost-effectively.

### SUMMARY

The present application presents a device for limiting rotation of a steering shaft, that is for limiting a maximum rotational angle through which the steering shaft can be rotated. It includes the steering shaft of a vehicle, which is preferably an electric vehicle. An outer tube surrounds the steering shaft. Stops are fixed in the outer tube. The steering shaft extends through the stops. A grooved sleeve includes a helical groove. The grooved sleeve is connected to the steering shaft so as to be rotationally fixed and axially displaceable. Counter-stops are formed on the grooved sleeve. The counter-stops are configured to come into contact with the stops when the steering shaft reaches a rotational end position. An engagement element is fixed to the outer tube and engages the helical groove.

In the device, the stops are fixed in the outer tube. There, they can be accommodated simply and in a space-saving manner. The steering shaft extends through the stops, which contributes particularly to the low space requirement. The grooved sleeve sits on the steering shaft, is axially displaceable along the steering shaft but rotationally fixed connected thereto, and has the counter-stops. Since the engagement element fixed to the outer tube engages in the helical groove of the grooved sleeve, the grooved sleeve is displaced thereon when the steering shaft rotates. As soon as the respective counter-stop comes into contact with the respective stop in the outer tube, further rotation of the steering shaft is no longer possible. The grooved sleeve with the helical groove contributes to a compact design.

The device limits the rotation angle of the steering shaft to a certain number of revolutions. The number of revolutions can be set by design. It may comprise full revolutions, partial revolutions, or, in addition to one or more full revolutions, also partial revolutions, in order to be able to precisely set the rotation angle of the steering shaft. The rotation angle limiting according to the invention can be completely accommodated between the outer tube and the steering shaft. The steering shaft can be accommodated in the outer tube such that it does not project axially beyond the outer tube.

The length of the groove determines the rotational range of the steering shaft. The groove advantageously extends over an angular range of more than 360°, preferably over an angular range of 900°. In this way, the rotation travel of the steering shaft relative to the outer tube can be fundamentally determined.

The helical groove is advantageously arranged on the outer surface of the grooved sleeve.

Advantageously, the engagement element has a holder which holds at least one rolling element, for example a roller or a ball, in the helical groove. If the roller has an axis of rotation that extends in a radial direction with respect to the tubes, the holder can engage in the groove with low friction in the adjustment direction of the tubes. This is because, when the roller comes into contact in the groove in the axial direction, it can roll along the contacted side wall of the groove. This promotes easy adjustability of the tubes.

Even easier adjustability can be achieved if the holder engages in the groove with a ball, because it also reduces friction relative to the groove base. Due to the friction-reducing effect of the rolling element, the pitch of the helical groove can be smaller, which enables a shorter grooved sleeve and benefits a compact design of the rotation angle limiting.

During its helical movement in the groove as a result of rotation of the steering shaft, the engagement element regularly exerts a torque on the grooved sleeve due to friction. A guide element, which guides the grooved sleeve axially displaceable but rotationally fixed, absorbs this torque. The guide element acts between the grooved sleeve and the steering shaft and can in principle be formed integrally with the grooved sleeve or with the steering shaft.

A disturbance-free axial movement of the grooved sleeve can advantageously be achieved in that the steering shaft has an axial guide on the jacket side, into which the guide element engages with low friction from the grooved sleeve. The axial guide may, for example, consist of a rail mounted on the inner or outer jacket of the tube, which encloses the guide element, or be formed as a groove or channel into which the guide element engages.

A particularly low-friction axial movement can be achieved if the above rotation angle limiting comprises a cage with rolling bodies as a separate guide element, which engages in a groove-shaped axial guide on the grooved sleeve. The guide element is arranged so as to be movable independently between the grooved sleeve and the steering shaft. It engages both in the axial guide on the steering shaft and in the axial guide on the grooved sleeve. The rolling elements, advantageously designed as balls, ensure efficient reduction of friction during the axial movement of the grooved sleeve on the steering shaft.

The stops are advantageously formed as rings which surround the steering shaft at a distance. In the stop position of the steering shaft, the stop rings can reliably absorb high forces.

In a preferred embodiment, stop surfaces are provided on the stop rings, which extend transverse to the rotational direction of the steering shaft or of the grooved sleeve.

Uniform loading of the steering shaft is advantageously achieved if the stop ring has two diametrically opposite stop surfaces.

A compact design is achieved if the diametrically opposite stop surfaces are connected to one another by helical surfaces, which lie in the end faces of the stop rings. The stop ring can thereby be kept very narrow.

The grooved sleeve advantageously has end faces which are at least approximately complementary to the adjacent end faces of the annular stops. As a result, the steering shaft is reliably blocked in the stop position.

In an advantageous embodiment, the engagement element penetrates the outer tube from its outer side and engages on the inner side in the groove of the grooved sleeve. The engagement element can thereby be inserted or adjusted from the outer side of the outer tube or, for example, replaced in the event of wear or damage.

### BRIEF DESCRIPTION OF THE DRAWINGS

The invention is explained in more detail on the basis of an embodiment shown in the drawings. In the drawings:

FIG. 1 shows a device for rotation angle limiting between the outer, sectioned tube and the inner tube of an adjusting device in a center position.

FIG. 2 shows the rotation angle limiting according to FIG. 1 in a left end position.

FIG. 3 shows the rotation angle limiting according to FIG. 1 in a right end position.

FIG. 4 shows the rotation angle limiting according to FIG. 1 in a partially sectioned view.

FIG. 5 shows the rotation angle limiting according to FIG. 1 or 4 in a view with hidden lines.

FIG. 6 shows, in a perspective representation, the rotation angle limiting according to FIG. 1 in a partially sectioned view.

FIG. 7 shows, in a perspective representation, a stop ring of the device.

FIG. 8 shows, in a perspective representation, a grooved sleeve of the device.

FIG. 9 shows, in a perspective representation, the grooved sleeve in a stop position at the stop ring.

### DETAILED DESCRIPTION

The device 1 for rotation angle limiting described below is part of a steering system of a generally electric steering column adjusting device. The steering system has a steering shaft 3, on the free end of which a steering element, such as a steering wheel, is fixed in a known manner.

The steering shaft 3 is surrounded by an outer tube 2 with radial play. The outer tube 2 and the steering shaft 3 have the common axis A. The steering shaft 3 is rotatably mounted in the outer tube 2. Between the outer tube 2 and the steering shaft 3, a device 4 for rotation angle limiting is arranged, hereinafter referred to as rotation angle limiting 4. The rotation angle limiting 4 limits the rotation of the steering shaft 3 relative to the outer tube 2 to a rotation angle of, for example, 900°. The rotation angle limiting 4 has a substantially cylindrical grooved sleeve 5, which sits on the steering shaft 3 rotationally fixed but axially displaceable and is surrounded by the outer tube 2 at a distance.

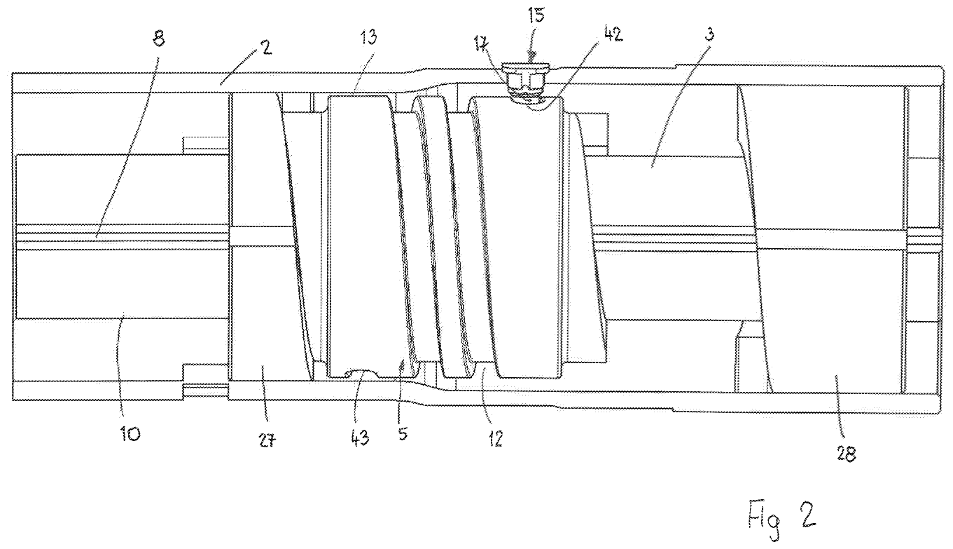

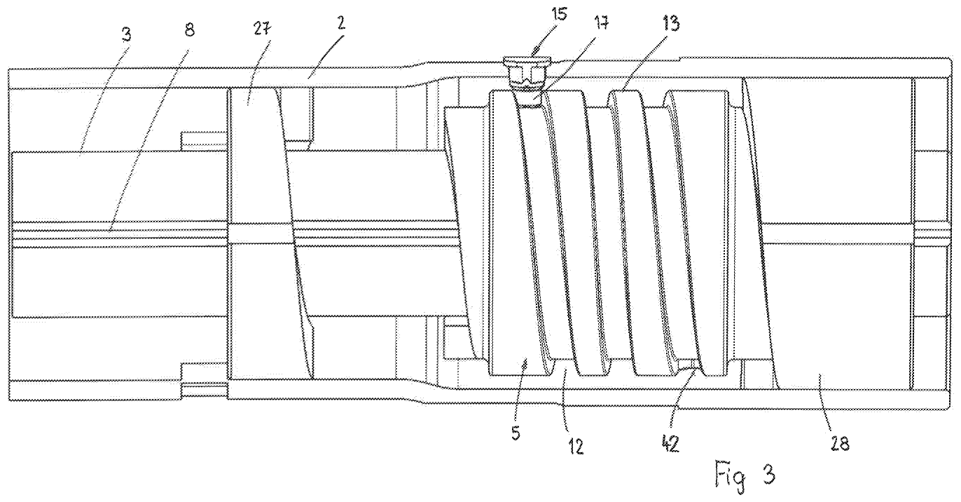

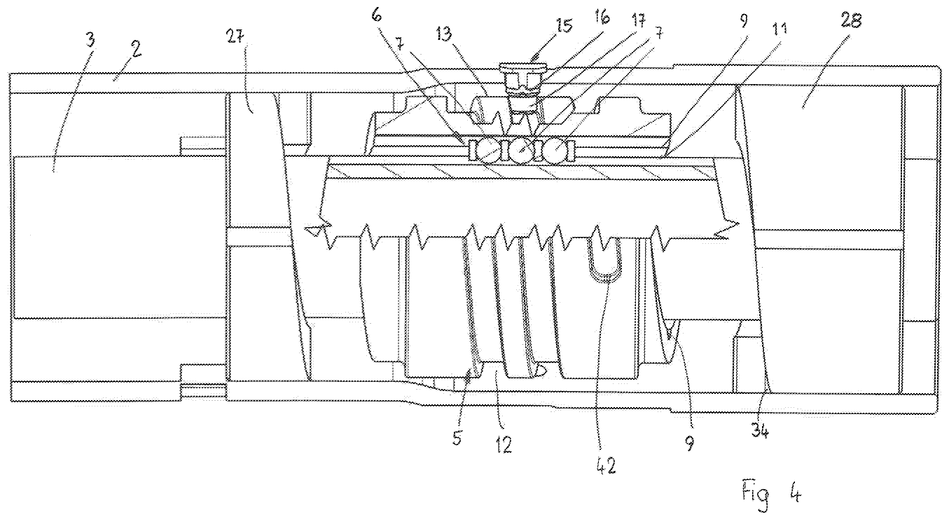

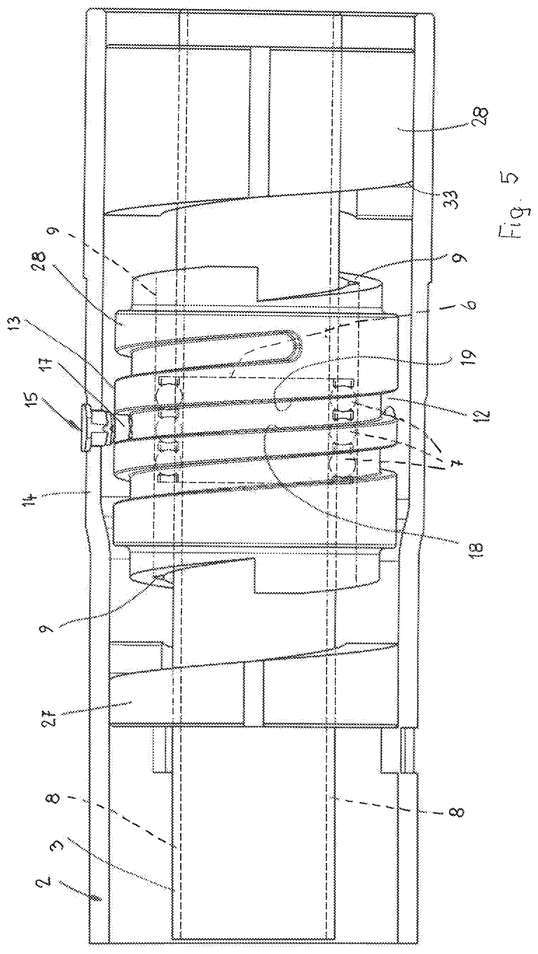

As shown in FIGS. 2 and 3 in plan view and in FIGS. 4 to 6, a cage 6 with rolling bodies 7, preferably balls, is arranged between the grooved sleeve 5 and the steering shaft 3. The cage 6 contains at least two triples of rolling bodies 7 lying axially next to one another and radially opposite each other on the steering shaft 3. They run both in a groove 8 extending axially on the outer side of the steering shaft 3 and in a groove 9 extending axially on the inner side in the grooved sleeve 5.

The groove 8 is formed in an outer surface 10 of the steering shaft 3 and forms an axial guide 8 on the outer side of the cage 6. The groove 9 is formed in an inner surface 11 of the grooved sleeve 5 and thus forms an axial guide 9 on the inner side of the cage 6 in the grooved sleeve 5.

The two axial guides 8, 9 and the cage 6 with the rolling bodies 7 enable an axial sliding of the grooved sleeve 5 on the steering shaft 3. They thereby form a guide element of the grooved sleeve 5 for its axial movement on the steering shaft 3.

The grooved sleeve 5 has, on the outer side in its outer surface 13, a helical groove 12. The helical groove 12 extends overall over an angular range of 900°, i.e., over two and a half revolutions.

From the outer tube 2 and through its wall 14, an engagement element 15 projects radially into the groove 12. The engagement element 15 is held fixed in the outer tube 2 by a holder 16. The holder 16 lies outside the groove 12 and holds a roller 17, which engages in the groove 12. The roller 17 is rotatably mounted in the holder 16 about an axis that extends radially with respect to the outer tube 2, 3. The roller 17 is set into rotation as soon as it comes into contact with side walls 18, 19 of the groove 12 as a result of a rotation of the steering shaft 3.

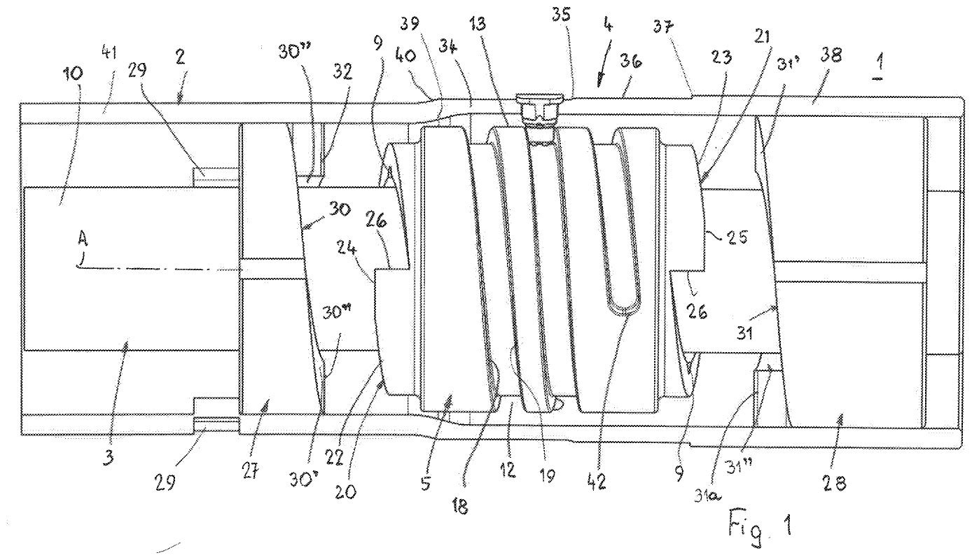

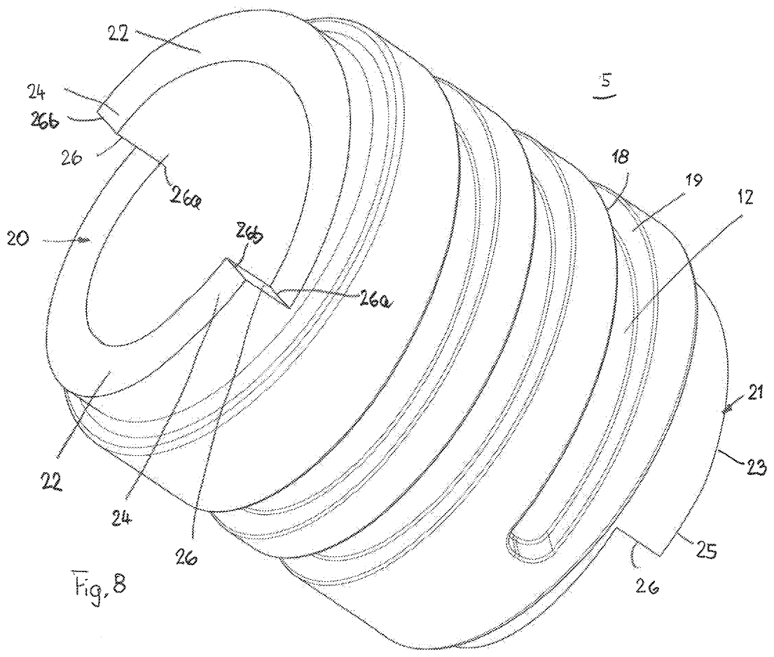

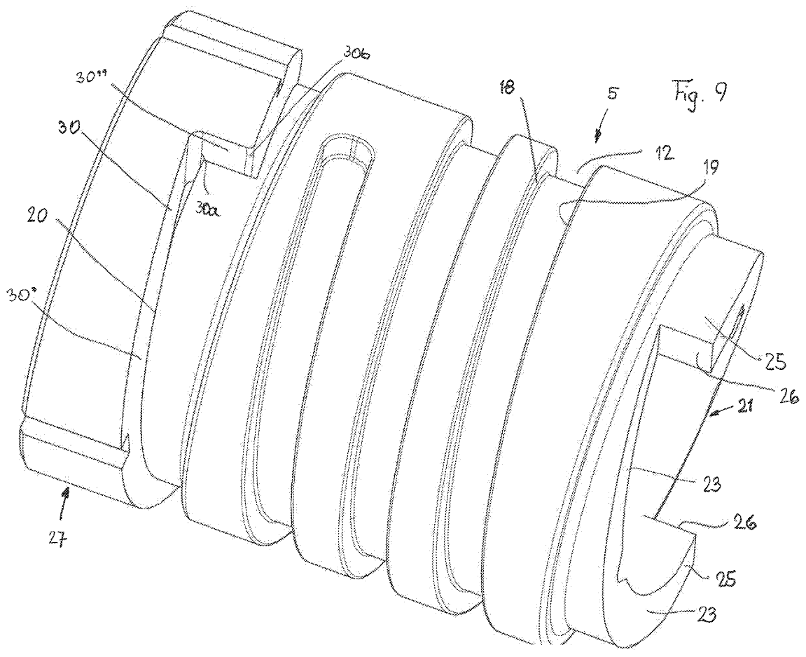

The grooved sleeve 5 has end faces 20, 21 on both sides, which appear annular in an axial plan view (FIGS. 8 and 9). As shown in FIGS. 1 to 6, 8 and 9, they each have helical surfaces 22, 23 and adjoining radial surfaces 24, 25.

As shown in FIGS. 8 and 9, the helical surfaces 22, 23 with the associated radial surfaces 24, 25 each extend over 180° and merge, in diametrically opposite regions, into stop surfaces 26, which are formed flat and lie in axial planes of the grooved sleeve 5. Advantageously, the stop surfaces 26 lie in the same axial plane of the grooved sleeve 5.

The helical surfaces 22, 23 each extend from the axially inner end 26a of one stop surface 26 and, with their radial surfaces 24, 25, connect to the axially outer end 26b of the other stop surface 26.

The two end faces 20, 21 of the grooved sleeve 5 may also have only the helical surfaces 22, 23, such that they extend between the ends 26a, 26b of the two stop surfaces 26.

Starting from the same axis-parallel generatrix of the outer surface 13 of the grooved sleeve 5, the helical surfaces 22, 23 extend, for example, right-handed, i.e., clockwise, and with constant pitch around the common axis A of the grooved sleeve 5.

On both sides of the grooved sleeve 5 and at an axial distance, stop rings 27, 28 are provided in the outer tube 2, which are preferably press-fitted and through which the steering shaft 3 extends with play. The narrower stop ring 27, located on the left side in FIGS. 1 to 6, is additionally supported axially on the outer tube 2 by inwardly directed staking 29.

The stop ring 27 has an end face 30, which faces the end face 20 of the grooved sleeve 5 and is configured correspondingly thereto. It also has two helical surfaces 30′, which wind with constant pitch and, for example, right-handed around the axis A, and to each of which a radial surface 32 adjoins.

The helical surfaces 30 and the associated radial surfaces 32 each extend over 180° and merge, in diametrically opposite regions, into stop surfaces 30″. These are formed flat and lie in axial planes of the stop ring 27. Advantageously, the stop surfaces 30″ lie in the same axial plane of the stop ring 27.

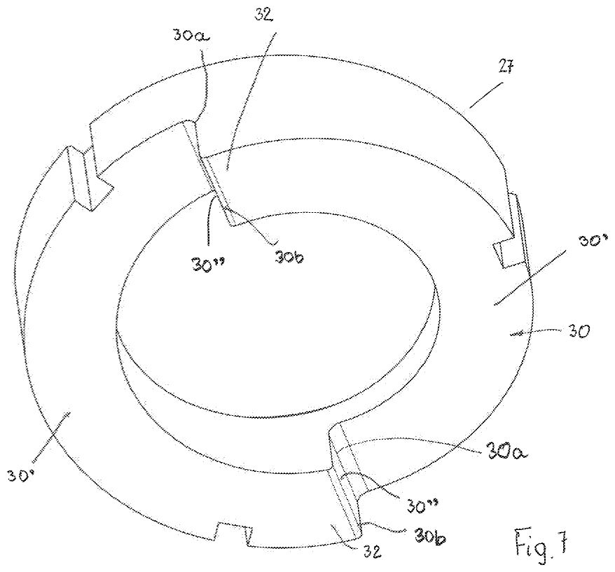

The helical surfaces extend in each case from the axially inner end 30a of one stop surface 30″ and, with their radial surfaces 32, connect to the axially outer end 30b of the other stop surface 30″ (FIG. 7).

The end face 30 of the stop ring 27 may also have only the two helical surfaces 30′, which extend between the two ends 30a, 30b of the stop surfaces 30″.

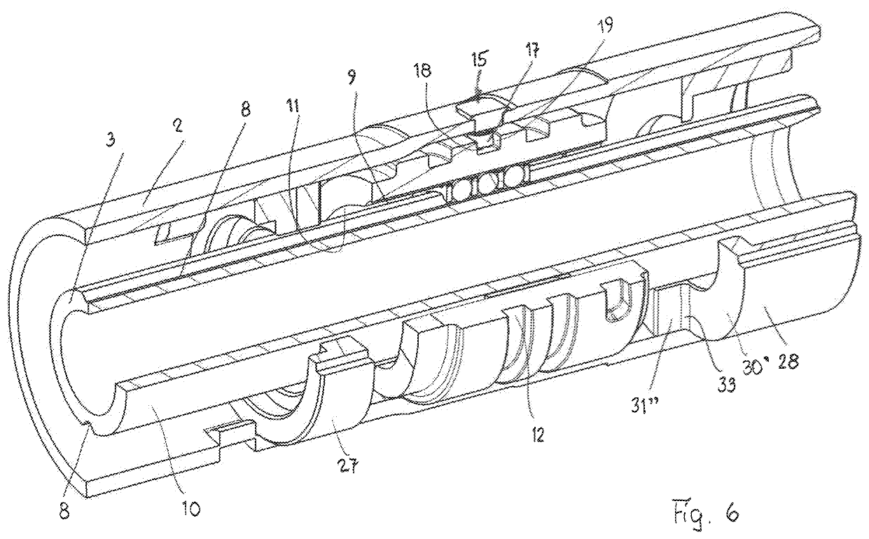

In a corresponding manner, the end face 31 of the wider stop ring 28 on the right side is formed with the helical surfaces 31′, the radial surfaces 31a, if provided, and the stop surfaces 31″ and is thus complementary to the end face 21 of the grooved sleeve 5. As shown in FIG. 6 for the stop surface 31″, the stop surfaces 30″, 31″ may merge into the helical surfaces 30′, 31′ with a fillet 33 due to manufacturing.

The end faces 20, 30 and 21, 31, which are complementary to one another, are provided such that the end faces 20, 21 of the grooved sleeve 5 only come into contact with the corresponding end faces 30, 31 of the stop rings 27, 28 in the stop position (FIGS. 2 and 3). During the axial movement and rotation of the grooved sleeve 5 still to be described, the axially projecting stop surfaces 26 can move past the axially projecting stop surfaces 30″, 31″ as long as the maximum rotation travel of the steering shaft 3 has not yet been reached.

The engagement element 15 is located in a wall section 34 of the outer tube 2 with constant wall thickness. In FIG. 1, to the right of the engagement element 15, the wall thickness increases slightly at an outer frustoconical surface 35. The adjoining wall section 36 of constant thickness transitions via an outer step 37 into a further wall section 38 with greater wall thickness.

The inner diameter of the outer tube 2 is constant in the region of the wall sections 34 to 38. To the left of the engagement element 15, both the inner diameter decreases at an inner frustoconical surface 39 and the outer diameter of the outer tube 2 decreases at an outer frustoconical surface 40, which lies approximately at the same height as the inner frustoconical surface 39. The inclination of the inner frustoconical surface 39 is, by way of example, greater than the inclination of the outer frustoconical surface 40, whereby the wall thickness of the outer tube 2 increases in FIG. 1 in the direction toward the stop ring 27. The adjoining wall section 41 of the outer tube 2 therefore has a greater thickness than in the region of the wall sections 34 to 36 and has approximately the same wall thickness as the wall section 38. However, due to the outer frustoconical surfaces 35, 40 and the step 37, the outer diameter of the wall section 41 is smaller than the outer diameter of the wall section 38.

The described configuration of the outer tube 2 is to be understood only as an example and not as mandatory. Depending on the application and installation conditions, the outer tube 2 may also have other configurations.

When the steering shaft 3 is set into rotation, the grooved sleeve 5, which is rotationally fixed connected thereto, also rotates. Due to its engagement in the groove 12, the engagement element 15 causes the grooved sleeve 5 to be displaced axially on the steering shaft 3. The roller 17 of the engagement element 15 rolls along the side wall 18, 19 of the groove 12 and allows low-friction sliding of the engagement element 15 in the groove 12 when the engagement element 15 is in contact with one of the side walls 18, 19 of the groove 12. The rotation forces the grooved sleeve 5, via the engagement element 15, into axial movement on the steering shaft 3. The cage 6 with the rolling bodies 7 ensures a low-friction linear movement of the grooved sleeve 5 on the steering shaft 3.

Starting from a zero position according to FIG. 1, in which the grooved sleeve 5 is located in the middle between the two stop rings 27, 28, the steering shaft 3 undergoes a rotation of up to a maximum of 450° until the engagement element 15 reaches the end 42 or 43 of the groove 12. FIG. 2 shows the left end position, in which the engagement element 15 abuts the end 42 and the grooved sleeve 5 comes into contact with the left stop ring 27. Due to the one and a quarter revolutions between the zero position of FIG. 1 and the end position of FIG. 2, the view of FIG. 2 is rotated by 90° relative to the view of FIG. 1, so that the axial guide 8, not visible in FIG. 1, can be seen.

In this case, not only do the helical surfaces 22, 30′ with their radial surfaces 24, 32, if present, come into contact with one another, whereby the axial linear movement of the grooved sleeve 5 and the rotation of the steering shaft 3 are terminated. Additionally, the stop surfaces 26, 30″, 31″ also come into contact with one another.

Since the stop surfaces 26, 30″, 31″ are diametrically opposite one another, the steering shaft 3 is loaded uniformly in the stop position.

In a corresponding manner, the right-side stop ring 28 acts, at whose stop surfaces 31″ the stop surfaces 26 of the grooved sleeve 5 come into contact. The helical surfaces 23, 31′ and, if present, the radial surfaces 25, 31a also come into contact in the end position. The helical surface 31′ corresponds to the helical surface 23 of the grooved sleeve 5. When the stop surfaces 26, 31″ come into contact in a right end position, as shown in FIG. 3, further linear movement of the grooved sleeve 5 to the right and thus further rotation of the steering shaft 3 is no longer possible.

The stop surfaces 26, 30″, 31″ of the grooved sleeve 5 and of the stop rings 27, 28 are advantageously of equal size, so that proper force transmission is ensured in the stop position.

The described device for rotation angle limiting is distinguished by its compact design. It lies completely between the outer tube 2 and the steering shaft 3. It can therefore be accommodated flexibly in terms of space in an adjusting device. It offers a robust construction, whereby a long service life can be expected.

The pitch of the groove 12 and of the helical surfaces 22, 23; 30′, 31′ can be optimally matched to one another depending on the application, so that the steering shaft 3 with the grooved sleeve 5 can be rotated properly within the steering range and is reliably blocked against further rotation in the stop positions.

What is claimed is:

1. A device, comprising:
a steering shaft (3) of a vehicle;
an outer tube (2) surrounding the steering shaft (3);
stops (27, 28) fixed in the outer tube (2), the steering shaft (3) extending through the stops (27, 28);
a grooved sleeve (5) including a helical groove (12), the grooved sleeve (5) being connected to the steering shaft (3) so as to be rotationally fixed and axially displaceable;
counter-stops (20, 21) formed on the grooved sleeve (5), the counter-stops (20, 21) being configured to come into contact with the stops (27, 28) when the steering shaft (3) reaches a rotational end position; and
an engagement element (15) fixed to the outer tube (2) and engaging the helical groove (12),
wherein rotation of the steering shaft relative to the outer tube is limited by the stops (27, 28) coming into contact with the counter-stops (20, 21).

2. The device according to claim 1,
wherein the helical groove (12) is arranged on an outer surface (13) of the grooved sleeve (5) and extends over more than 360°.

3. The device according to claim 1,
wherein the engagement element (15) includes a holder (16) configured to hold a rolling element (17) in the helical groove (12).

4. The device according to claim 1,
wherein the steering shaft (3) has an axial guide (8) on a jacket side, into which a guide element (6, 7) engages.

5. The device according to claim 4,
wherein the guide element (6, 7) comprises a cage (6) with rolling bodies (7), and
wherein the guide element (6, 7) engages in an axial guide (9) of the grooved sleeve (5).

6. The device according to claim 1,
wherein the stops (27, 28) are formed annular and surround the steering shaft (3) at a distance.

7. The device according to claim 6,
wherein the stops (27, 28) have stop surfaces (30″, 31″) extending transverse to a rotational direction of the steering shaft (3) or of the grooved sleeve (5).

8. The device according to claim 7,
wherein the stops (27, 28) have two diametrically opposite stop surfaces (30″, 31″).

9. The device according to claim 8,
wherein the stop surfaces (30″, 31″) are connected to one another by helical surfaces (30′, 31′) in end faces (30, 31) of the stops (27, 28).

10. The device according to claim 1,
wherein the grooved sleeve (5) has end faces (20, 21),
wherein the end faces (20, 21) are formed at least approximately complementary to adjacent end faces (30, 31) of the stops (27, 28).

11. The device according to claim 1,
wherein the engagement element (15) extends through a jacket (14) of the outer tube (2) from an outer side.
